(19) United States
(12) Patent Application Publication
(10) Pub. No.: US 2007/0061530 A1
(43) Pub. Date: Mar. 15, 2007

(54) Method for storage of digital data in a mainframe data center and associated device

(76) Inventors: Charles-Yves Bourhis, Saint-Herblain (FR); Jean-Francois Sourisseau, Saint Mars De Coutais (FR)

Correspondence Address: YOUNG & THOMPSON, 745 SOUTH 23RD STREET, 2ND FLOOR, ARLINGTON, VA, 22202, US

(21) Appl. No.: 11/516,582

(22) Filed: Sep. 7, 2006

(30) Foreign Application Priority Data
Sep. 9, 2005 (FR) 05 09211

(51) Int. Cl. G06F 12/16; G06F 12/00

(52) U.S. Cl. 711/162; 711/118; 711/111

(57) ABSTRACT

Method for storage, in a mainframe data center, digital data obtained from a mainframe that includes a storage device, by (A) copying digital data on a direct access storage device, called a cache, thus creating a logical backup of the data, (B) copying, on a physical substrate different from the cache and from the storage device of the computer, the logical backup of the digital data created during step (A), then deleting the data of the first backup present in the cache, wherein the data of the logical backup created during step (A) are stored in the cache so as to be recognized by the computer as direct access data and after step (B), the data obtained from step (A) remain present in the cache, the elimination of data being parameterized by the computer.

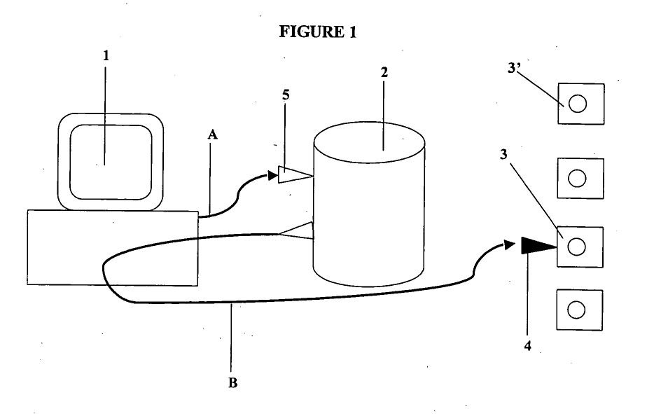

### BACKGROUND

The invention relates to a method for storage, in a mainframe data center, of digital data obtained from at least one mainframe that comprises a storage device, whereby said method comprises at least a first step of copying said digital data on means forming a direct access storage device (DASD), called a cache, in particular disk buffers, thus creating a logical backup of said data, then at least a second step of copying, on a physical substrate that is different from the cache and from the mainframe central storage, the logical backup of the digital data created during said first copying step, then a third step of deleting of the data of the first backup present in the cache.

The invention also relates to an associated device, making it possible to store digital data of a mainframe data center, of the type comprising at least one mainframe, means forming a direct access storage device called a cache, means forming a secondary storage, whereby said secondary storage has a physical substrate that is different from the cache and from the mainframe central storage, and means for reading and writing on each of said storage devices.

The storage of digital data in a mainframe data center and the exportation, on different physical substrates, into different locations, generate problems that are well known to one skilled in the art. Actually, the preservation of data is necessary in this type of structure, in particular for preventing the loss of an excessive quantity of data during, in particular, a system crash or a disaster on the premises. Thus, in a large majority of businesses implementing a device that uses a mainframe data center, the data are copied on exportable physical substrates, i.e., physically movable to be preserved in different locations. In general, and primarily for reasons of cost, said substrates that are used are magnetic tapes.

A mainframe data center is called an organization of one or more mainframes with high-power processing. These mainframes have the capacity of simultaneously executing various computer applications (general purpose) (as opposed to servers that are dedicated to given or specialized tasks) and simultaneously addressing various peripheral units. The mainframe data centers are used in particular in the industries that handle large quantities of computer data or large databases, in particular banks or insurance companies.

Most of the methods for storage of digital data, intended to be exported, implemented in mainframe data centers, are virtual tape libraries for mainframes. In addition to the computers from which the data are emitted, the corresponding devices comprise a buffer storage called a cache and a set of magnetic tapes and drives that make possible the reading and writing on these tapes. The use of a buffer storage allows access to certain data without having to position physically the corresponding magnetic tape in a drive and then to lock it at the location where the data to which access is desired are recorded. It therefore makes possible a considerable saving of time.

The cache being of limited size, however, it is necessary to empty it periodically. The existing devices, called virtual tape libraries, generally have recourse to processes that have an integrated system for management of the process for emptying the cache. In general, this emptying is performed when the filling level of the cache reaches a predefined threshold. One criterion, such as the frequency of use, for example, makes it possible to determine what data can be deleted from the cache on a priority basis. The selected data are then copied on magnetic tape and then deleted from the cache, directly after their copying. The copying operation requires a certain time due, on the one hand, to the writing on a magnetic tape but also to the time for mechanical installation of the tape in the drive. The maximum rate of filling the cache by all of the computers that copy data there should therefore be less than the data flow rate between cache and magnetic tape to avoid any saturation of the cache. The flow rate of such a method is therefore limited. In addition, in the case of a breakdown between the cache and the magnetic tape drives, the cache furthermore continuing to receive new data and therefore to fill up, there is a problem of a freezing-up of the operations or applications using the cache.

Another drawback of such a method comes from the fact that it is not very profitable, in terms of performance levels and management of the free space, to write data reliably at the end of an already written tape if the latter has been withdrawn from the drive. The writing of data on the tapes takes place, however, each time that the space is necessary on the cache. Thus, small quantities of data are written on tapes at different moments, which poses a problem of filling magnetic tapes. The users of such systems generally accept that data that are obtained from different sources or environments are written on the same tape so as prevent losing excessive storage space, which poses safety problems, in particular in the case of a data mixture whose safety levels are different. Failing that, this leads to the necessity of physically storing a larger number of tapes, considerably increasing the storage cost and posing performance problems in the emptying of the cache.

Another drawback of the existing methods results from the fact that these so-called integrated systems use their own processors and software for initiating copies of data. These software programs have their own encoding algorithms, so, it is very difficult today to reuse a magnetic tape that is obtained from one mainframe data center in another. In addition, whereby magnetic tape drives are not managed by the computer of the user, their allocation without reconfiguration for other tasks is impossible, which also increases the weight of the device.

One object of the invention is to propose a method for storage of digital data that makes it possible to quickly release space in the cache so as to allow a filling rate of the cache that is more than that of the traditional installations and to remedy problems of safety, reliability and performance that are associated with a saturation of the cache.

Another object of the invention is to propose a device for storage of digital data that makes possible a facilitated exporting of created copies as well as an allocation that can be modulated by writing means on the tapes.

### SUMMARY

To this end, the invention has as its object a method for storage, in a mainframe data center, of digital data that are obtained from at least one mainframe comprising a storage device, whereby said method comprises at least a first step of copying said digital data on means that form a direct access storage device, called a cache, in particular disk buffers, thus creating a logical backup of said data, then at least a second step of copying, on a physical substrate that is different from the cache and from the mainframe central storage, the logical backup of the digital data created during said first step of copying, then a third step for deleting data from the first backup present on the cache, characterized in that the data of the logical backup created during the first step of copying are stored in the cache so as to be recognized by the mainframe as direct access data and in that, when the second step of copying is finished, the data that are obtained from the first step of copying remain present in the cache, whereby deleting said data can be parameterized by means of at least one of said mainframes.

This method applies most particularly to data recognized by the mainframe as direct access data. Actually, the methods described above store the data that are intended to be written on a tape in the form of virtual magnetic tapes. It then is necessary to use an interface allowing the reading of the thus stored data and to repatriate them to a mainframe. The method that is the object of the invention therefore eliminates the need for said interface by storing the data in the cache in the form of disk data.

Thus, a copy of the data of the cache is generally created on tape well before deleting these data is necessary. If necessary, said data can be deleted from the cache without having to wait for their copying on tape to be carried out. The freeing-up of storage space in the cache is therefore considerably accelerated.

The invention also has as its object a device for storage of digital data of a mainframe data center of the type that comprises at least one mainframe, means that form a direct access storage device, called a cache, means forming a secondary storage, said secondary storage having a physical substrate that is different from the cache and from the mainframe storage, and means for reading and writing on each of said storage devices, characterized in that said means that make possible the reading and writing of data on the cache or on the secondary storage can be accessed directly by the mainframe so that in particular the communication between cache and secondary storage can be parameterized by means of at least one mainframe so as to be able to implement a method of the above-mentioned type and thus to emulate a virtual tape library.

In the device according to this invention, the originality comes from the fact that the entire backup method that it makes it possible to use can be controlled by the mainframe. Furthermore, the use of a mainframe, i.e., controlled directly by a user and not integrated with the storage device (i.e., not built specifically for the storage device), makes it possible in particular to allocate to different tasks the means for writing on the secondary storage.

This method and this device make possible the emulation of a virtual tape library in a mainframe data center, using a mainframe (and not a dedicated server), and standard disks and tape drives, i.e., not specifically built or programmed for this usage.

The invention will be well understood from reading the following description of an embodiment, in reference to the accompanying drawing showing a schematic view of the device that is the object of the invention.

### PREFERRED EMBODIMENT

As shown in the FIGURE, the device according to the invention comprises at least one mainframe 1, means 2 that form a direct access storage that is called a cache, means 3, 3′ that form a secondary storage, whereby said secondary storage has a physical substrate that is different from cache 2 and the mainframe central storage 1 such as magnetic tapes 3, and means 4, 5 for reading and writing on each of said storage devices 2, 3, in particular drives 4. The originality of this device comes from the fact that the entire backup method that it makes it possible to use can be monitored by mainframe 1. Thus, said means 4, 5 that allow the reading and writing of the data on the cache 2 or on the secondary storage 3 can be accessed directly by the mainframe 1, so that in particular the communication between cache 2 and secondary storage 3 is parameterized by means of at least one mainframe 1 so as to be able to implement a method of the above-mentioned type and thus to emulate a virtual tape library. If the secondary storage that is used consists of magnetic tapes, the means 4 for reading and writing that are used are drives. The means 5 for writing and reading on a disk-type cache 2 are actually reading and writing heads that are integrated in said disks.

In the most frequent case where several mainframes 1 use the same device to carry out the storage of their data, the drives 4 and the means 5 for reading and writing on cache 2 can also be shared between said mainframes 1. Nevertheless, preferably storage devices 2, 3 and 3′ are not shared between the mainframes, whereby this configuration prevents the interactions between the mainframes, thus improving the reliability, the performance level and the safety of the device. All of the operations that end in the storage of digital data being monitored by the mainframe or mainframes 1, it is not necessary to provide a means for direct connection between cache 2 and magnetic tapes 3. Direct connection is defined as a possibility of communication between two elements, optionally through connectors, without the communicated data being modified or stored on another machine. Thus, the virtual tape library that is emulated by means of the device that is the object of the invention does not comprise a direct connection between cache 2 and secondary storage 3, whereby all of the functions of said tape library can be actuated by means of a mainframe 1.

Physically, the cache 2 can be formed by a standard direct access storage device (DASD) structure. It then is possible for a business to use old disks to produce the cache, which was impossible with the traditional devices, since the cache formed an integral part of the virtual tape library. This leads to a considerable reduction of the cost of the device. In addition, whereby the structure can be modulated, it is easy to add disks to add space to the cache. This operation previously required the intervention of the manufacturers of the virtual tape library and the use of a specific type of disk to add space. In a preferred embodiment, the secondary storage device 3 on which the second step B of copying is carried out consists of magnetic tapes 3 that can be read and written on by means of drives 4. The tapes 3 are used for reasons of cost. In effect, the cost of the storage on tape is actually about ten times lower than that on disk. It is not ruled out, however, that another type of storage, such as other disks, for example, is used as secondary storage 3.

The method that is the object of the invention relates in particular to the digital data that are stored in the cache 2 so as to be recognized by the mainframe 1 as direct access data. This term is used in particular in opposition to sequential access data, used in current storage devices such as virtual tapes, which are stored in the cache but are recognized by the applications of the mainframe as magnetic tapes. These digital data, generally consisting of a large number of files, are the data that pose the most problem of storage on the magnetic tapes. Actually, the large number of files necessitates a synchronization of the copying of said files on a magnetic tape to obtain an effective filling of said tapes.

The method that is the object of the present invention comprises several steps, including at least a first step A of copying digital data so as to create backup of said data. In the remainder of this text, the word copying will be used to designate the action of reproducing the digital data to a storage space that is different from the one where they are found whereas the word backup will be used to designate the data created during copying. The first step A of copying this process therefore consists in copying the digital data that are to be preserved to a buffer storage, called a cache 2, so as to create a first backup of said data on a substrate that is different from the storage of said mainframe. The thus created backup in the buffer storage 2 should then be copied on a physical substrate 3 that is different from cache 2 and from the mainframe central storage 1 so as to use an exportable backup of this first backup.

The backup that is obtained from the first step A of copying is then copied on a tape 3 during the second step B of copying. The difference with the conventional methods comes from the fact that said backup that is thus copied on tape 3 is not eliminated directly from cache 2 once the second step B of copying is completed. In addition, the parameters that initiate this second step B of copying are also very different from the existing methods. Actually, the method that is the object of the invention does not use an additional computer for managing the copying on tape 3 of data that are present on the cache 2. All of these operations are monitored by the mainframe 1, which makes it possible for the user to determine at what moment the second step B of copying is to be initiated. Whereby this copy makes unnecessary the additional processor that is present in the traditional virtual tape libraries, the second step B of copying uses the mainframe central storage 1. Thus, the logical backup data created during the first step A of copying, whereby said data are obtained from cache 2 and intended to be written on a physical substrate 3 that is different from cache 2 and from the mainframe central storage 1, pass through at least one mainframe 1 before being sent to the substrate 3 so that the second step B of copying can be parameterized by the user of a mainframe 1 and so that the moment of initiating said second step B can be independent of the filling level of cache 2. This design provides total control to the user of this second step B of copying. In a general manner, said second step B is initiated the earliest possible after the first step A of copying so as to have a backup on magnetic tape 3 of the data that are present in cache 2 as soon as it is necessary to free up the space in cache 2.

In addition, whereby the second step B of copying data from the cache to magnetic tapes 3 is integrally monitored by the mainframe 1 and its user, the type of data copied on the tapes 3 is no longer dependent on the virtual tape library that is used, contrary to traditional methods, in which the integrated processor had his own encoding algorithm. Thus, it is possible to use magnetic tapes 3 containing the backups of digital data, which are easily exportable and readable by other storage devices.

In practice, the second step B of copying data that are present in the cache 2 is initiated periodically, according to a predefined frequency, whereby said second step B of copying consists in the copying, to a substrate 3 that is different from the cache 2 and the mainframe central storage 1, of digital data that are present in the cache that has not previously undergone second step B of copying. Other criteria can be considered to determine what data of the cache are to be copied on tapes 3. It is important, however, to initiate said second step B of copying a data item before needing to delete said data item from cache 2. Thus, when it is necessary to free up space in the cache 2, said data item can be instantaneously deleted from the cache without having previously carried out its copying on tape 3. Whereby the second step B of copying uses the mainframe central storage 1 for sending through the data from the cache 2 to the tapes 3, a lowering of the performance level of said mainframe 1 is to be provided during said second step B. Thus, in a preferred embodiment, the second step B of copying digital data is carried out during the periods of low activity of the mainframe 1 through which these data pass, in particular at night. It thus is possible to use the resources of the mainframe 1 without causing problems for the user of the latter.

In addition, whereby the second step B of copying takes place periodically and not specifically in case of a need for space in the cache 2, a larger quantity of data than in the traditional installations can be copied each time that such a second step B of copying is initiated. Thus, it is possible to obtain a better filling of the magnetic tapes 3 that are used, while using a lower number of drives than traditional systems. The fact of making the copy of files from the cache 2 to magnetic tapes 3 before actually having need of them makes it possible to copy more data at one time and to place data in the cache 2 that can be deleted instantaneously, if necessary. It then is possible to use high-capacity magnetic tapes 3, which considerably reduces the necessary number of tapes and their storage cost. In addition, the significant quantity of data to be copied at each second step B makes it possible to avoid copying data obtained from several sources on the same tape, thus improving the safety of the device.

For safety reasons, it is also possible that several backups from the same set of data on magnetic tapes 3 are necessary. The users of the computer system may want, for example, to have backups of said data on several physically separate locations so as to preserve the data in the case of a disaster, such as a fire, on one of the sites. Thus, several occurrences of the second step B of copying can be provided, carried out in a manner that may or may not be synchronized, on physical substrates (3, 3′) that are different from one occurrence to the next, so as to use several backup copies from the same set of digital data.

Once the data of the cache 2 are copied on magnetic tape 3, said data generally remain present in the cache 2 for a certain period so as to remain quickly accessible to the users of the mainframes 1. The deletion of said data, already copied onto tapes 3, can be carried out according to several criteria. The user of the mainframe 1 from where the data are obtained can, for example, parameterize the time during which said data will remain in the cache 2. In the case of excessive filling of the cache 2, certain data should also be deleted. Various criteria, such as the frequency of use, for example, make it possible for the mainframe 1 to determine the data to be deleted from the cache 2 on a priority basis. In addition, most of the files that have been copied onto the cache 2 are regularly the object of modifications and updates. This leads to the creation of another version for backing up data of said file. In this case, reference is made to a subsequent version of the file or data. It then is not necessary to preserve in the cache 2 the prior version of said file since in general only the most recent version is used. Thus, the step for deleting a set of digital data present in the cache 2 is initiated when a subsequent version of said set of data is present in the cache and/or when the presence of said set of data in the cache exceeds a predetermined time and/or when the filling level of the cache 2 reaches a predefined threshold.

1. Method for storage, in a mainframe data center, of digital data obtained from at least one mainframe (1) that comprises a storage device, whereby said process comprises at least a first step (A) of copying said digital data on means (2) forming a direct access storage device, called a cache, in particular disk buffers, thus creating a logical backup of said data, then at least a second step (B) of copying, on a physical substrate (3) that is different from the cache (2) and from the mainframe central storage (1), the logical backup of the digital data created during said first step (A) of copying, then a third step of deleting of the data of the first backup present in the cache (2),characterized in that the data of the logical backup created during the first step (A) of copying are stored in the cache (2) so as to be recognized by the mainframe (1) as direct access data and in that, when the second step (B) of copying is finished, the data that are obtained from the first step (A) of copying remain present in the cache (2), the deleting of said data being parameterized by means of at least one of said mainframes (1).

2. Method for storage, in a mainframe data center, of digital data according to claim 1, wherein the data of the logical backup created during the first step (A) of copying, whereby said data are obtained from the cache (2) and are intended to be written on a physical substrate (3) that is different from the cache and the mainframe central storage (1), pass through at least one mainframe (1) before being sent to said substrate (3) so that the second step (B) of copying can be parameterized by the user of a mainframe (1) and wherein the moment of initiating said second step (B) can be independent of the filling level of cache (2).

3. Method for storage, in a mainframe data center, of digital data according to claim 1, wherein the second step (B) of copying data that are present in the cache (2) is initiated periodically, according to a predefined frequency, whereby said second step (B) of copying consists in the copying, to a substrate (3) that is different from the cache (2) and from the mainframe central storage (1), of digital data that are present in the cache (2) that have not previously undergone the second step (B) of copying.

4. Method for storage, in a mainframe data center, of digital data according to claim 2, wherein the second step (B) of copying digital data is carried out during the low-activity periods of the mainframe (1) through which these data pass, in particular at night.

5. Method for storage, in a mainframe data center, of digital data according to claim 1, wherein there are provided several occurrences of the second step (B) of copying, carried out in a manner that may or may not be synchronized, on physical substrates (3, 3′) that are different from one occurrence to the next, so as to use several backup copies from the same set of digital data.

6. Method for storage, in a mainframe date center, of digital data according to claim 1, wherein the step of deleting a set of digital data present in the cache (2) is initiated when a subsequent version of said set of data is present in the cache (2) and/or when the presence of said set of data in the cache (2) exceeds a predetermined period and/or when the filling level of the cache (2) reaches a predefined threshold.

7. Device for storage of digital data of a mainframe data center of the type that comprises at least one mainframe (1), means (2) forming a direct access storage device, called a cache, means (3) forming a secondary storage, whereby said secondary storage (3) has a physical substrate that is different from the cache (2) and the mainframe central storage (1), and means (4, 5) for reading and writing on each of said storage devices (3, 3′), wherein said means (4, 5) that allow the reading and the writing of data on the cache (2) and the secondary storage (3) are directly accessible by the mainframe (1), in particular so that the communication between cache (2) and secondary storage (3) can be parameterized by means of at least one mainframe (1) so as to be able to implement a method according to one of claims 1 to 6 and thus to emulate a virtual tape library.

8. Device for storage of digital data from a mainframe data center according to claim 7, wherein the cache (2) is formed by a structure of direct access storage devices.

9. Device for storage of digital data of a mainframe data center according to claim 7, wherein the secondary storage (3) consists of magnetic tapes that can be read and written on by means of drives (4).

10. Device for storage of digital data of a mainframe data center according to claim 7, wherein the virtual tape library that is emulated by means of said device does not comprise a direct connection between cache (2) and secondary storage (3), whereby all of the functions of said tape library can be actuated by means of a mainframe (1).

11. Device for storage of digital data of a mainframe data center according to claim 8, wherein the secondary storage (3) consists of magnetic tapes that can be read and written on by means of drives (4).

12. Device for storage of digital data of a mainframe data center according to claim 8, wherein the virtual tape library that is emulated by means of said device does not comprise a direct connection between cache (2) and secondary storage (3), whereby all of the functions of said tape library can be actuated by means of a mainframe (1).

13. Device for storage of digital data of a mainframe data center according to claim 9, wherein the virtual tape library that is emulated by means of said device does not comprise a direct connection between cache (2) and secondary storage (3), whereby all of the functions of said tape library can be actuated by means of a mainframe (1).

14. Method for storage, in a mainframe data center, of digital data according to claim 2, wherein the second step (B) of copying data that are present in the cache (2) is initiated periodically, according to a predefined frequency, whereby said second step (B) of copying consists in the copying, to a substrate (3) that is different from the cache (2) and from the mainframe central storage (1), of digital data that are present in the cache (2) that have not previously undergone the second step (B) of copying.
